(19) United States
(12) Patent Application Publication
(10) Pub. No.: US 2026/0304481 A1
(43) Pub. Date: Oct. 1, 2026

(54) TXSPG CAPABILITY INDICATION

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Frisco, TX (US); Bilal Sadiq, Plano, TX (US)

(21) Appl. No.: 19/569,931

(22) Filed: Mar. 17, 2026

Related U.S. Application Data
(60) Provisional application No. 63/781,041, filed on Mar. 31, 2025.

(51) Int. Cl. H04W 74/0816; H04W 8/22; H04W 76/14

(52) U.S. Cl. CPC H04W 74/0816; H04W 8/22; H04W 76/14

(57) ABSTRACT

Transmission opportunity (TXOP) sharing for peer to peer (P2P) group (TXSPG) capability indication. A method performed by a non-access point (AP) station (STA) is provided. The method includes identifying whether the non-AP STA supports transmission opportunity (TXOP) sharing for a peer to peer (P2P) group (TXSPG) operation, setting a value of a TXSPG support field of an ultra-high reliability (UHR) medium access control (MAC) capabilities information field of a UHR capabilities element to indicate whether the non-AP STA supports the TXSPG operation, and transmitting a frame including the TXSPG supported field.

### CROSS-REFERENCE TO RELATED APPLICATIONS AND CLAIM OF PRIORITY

This application claims priority under 35 U.S.C. § 119 (e) to U.S. Provisional Patent Application No. 63/781,041 filed on Mar. 31, 2025. The above-identified provisional patent application is hereby incorporated by reference in their entirety.

### TECHNICAL FIELD

This disclosure relates generally to wireless networks. More specifically, this disclosure relates to a transmission opportunity (TXOP) sharing for a peer to peer (P2P) group (TXSPG) capability indication.

### BACKGROUND

WLAN technology allows devices to access the internet in the 2.4 GHz, 5 GHZ, 6 GHZ or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

This disclosure provides apparatuses and methods for TXSPG capability indication.

In one embodiment, a method performed by a non-access point (AP) station (STA) is provided. The method includes identifying whether the non-AP STA supports TXSPG operation, setting a value of a TXSPG support field of an ultra-high reliability (UHR) medium access control (MAC) capabilities information field of a UHR capabilities element to indicate whether the non-AP STA supports the TXSPG operation, and transmitting a frame including the TXSPG supported field.

In another embodiment, a method performed by an AP is provided. The method includes receiving, from a non-AP STA, a frame including a TXSPG support field of an UHR MAC capabilities information field of a UHR capabilities element, identifying, based on a value of the TXSPG support field, whether the non-AP STA supports TXSPG operation, and transmitting a frame to the non-AP station based on the identification.

In yet another embodiment, a AP station STA is provided. The non-AP STA includes at least one processor including processing circuitry and memory storing instructions. The instructions, when executed by the at least one processor individually or collectively, cause the non-AP STA to identify whether the non-AP STA supports a TXSPG operation; set a value of a TXSPG support field of an UHR MAC capabilities information field of a UHR capabilities element to indicate whether the non-AP STA supports the TXSPG operation; and transmit a frame including the TXSPG supported field.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP MLD according to various embodiments of the present disclosure;

FIG. 2B illustrates an example non-AP MLD according to various embodiments of this disclosure;

FIG. 3 illustrates an example network where infrastructure traffic and non-infrastructure traffic coexist according to embodiments of the present disclosure;

FIG. 4 illustrates an example method for capability field setting logic for a STA according to embodiments of the present disclosure;

FIG. 5 illustrates an example method for capability field setting logic for a UHR AP according to embodiments of the present disclosure;

FIG. 6 illustrates an example method for determining TXSPG non-AP STA status according to embodiments of the present disclosure;

FIG. 7 illustrates an example method for determining TXSPG AP status according to embodiments of the present disclosure;

FIG. 8A a diagram illustrating determination of whether a STA is a TXSPG requesting STA according to embodiments of the present disclosure;

FIG. 8B illustrates a format of a UHR MAC capabilities information field according to embodiments of the present disclosure;

FIG. 9 illustrates an example method for TXOP return support in TXSPG field setting for a non-AP STA according to embodiments of the present disclosure;

FIG. 10 illustrates an example method for TXOP Return support in TXSPG field setting for an AP according to embodiments of the present disclosure;

FIG. 11 illustrates an example method for setting of the TXSPG Support field and TXOP Return Support in TXSPG field, and the corresponding determination of the nature of the TXSPG operation between an AP1 and STA according to embodiments of the present disclosure;

FIG. 12 illustrates an example method for setting of the TXSPG Support field and TXOP Return Support in TXSPG field, and the corresponding determination of the nature of the TXSPG operation between AP1 and STA1 according to embodiments of the present disclosure;

FIG. 13 illustrates an example method for setting of the TXSPG Support field and TXOP Return Support in TXSPG field, and the corresponding determination of the nature of the TXSPG operation between AP1 and STA1 according to embodiments of the present disclosure;

FIG. 14 illustrates an example method for setting of the TXSPG Support field and TXOP Return Support in TXSPG field, and the corresponding determination of the nature of the TXSPG operation between AP1 and STA1 according to embodiments of the present disclosure; and

FIG. 15 illustrates an example method for setting of the TXSPG Support field and TXOP Return Support in TXSPG field, and the corresponding determination of the nature of the TXSPG operation between AP1 and STA1 according to embodiments of the present disclosure.

### DETAILED DESCRIPTION

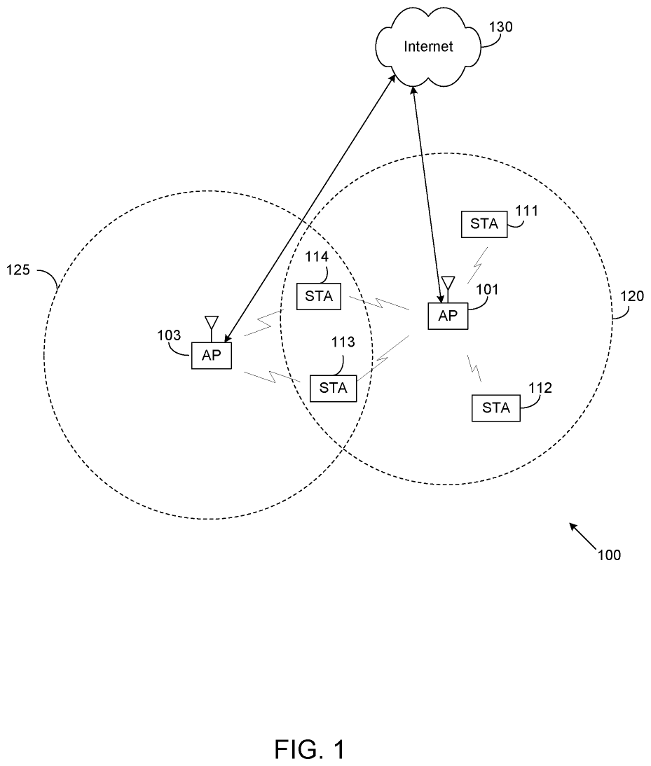

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an AP and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

The following documents and standards descriptions are hereby incorporated into the present disclosure as if fully set forth herein: [1] IEEE P802.11be—D3.0 “Part 11: Wireless LAN Medium Access Control (MAC) and Physical Layer (PHY) Specifications—Amendment 8: Enhancements for extremely high throughput (EHT)” and [2] IEEE P802.11REVme-D2.1“Part 11: Wireless LAN Medium Access Control (MAC) and Physical Layer (PHY) Specifications.”.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for TXSPG capability indication. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

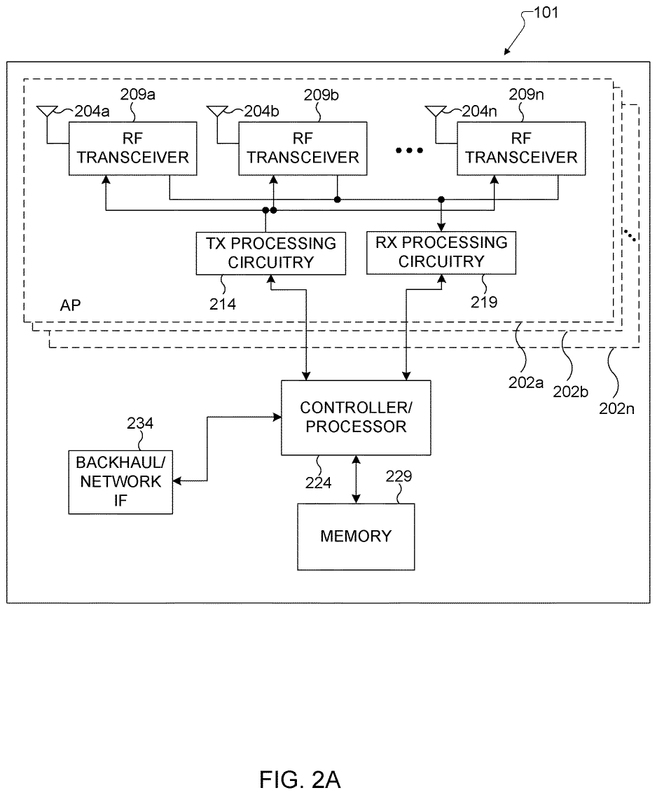

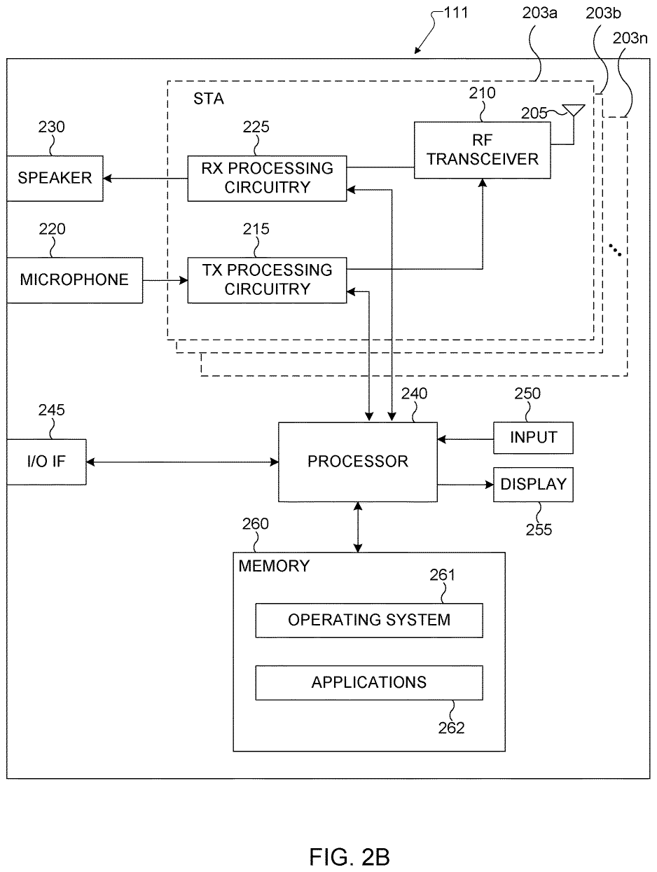

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In one or more of the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including TXSPG capability indication. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for TXSPG capability indication. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In one or more of the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate TXSPG capability indication. In some embodiments, the processor 240 includes at least one microprocessor or microcontroller.

The processor 240 is also capable of executing other processes and programs resident in the memory 260, such as operations for TXSPG capability indication. The processor 240 can move data into or out of the memory 260 as required by an executing process. In some embodiments, the processor 240 is configured to execute a plurality of applications 262, such as applications for TXSPG capability indication. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure recognize and take into consideration that support for low-latency applications is desired in WLAN systems. Numerous devices may operate on the same network. Many of such devices may be latency-tolerant but still contend with the devices with low-latency applications for the same time and frequency resources. In some cases, the AP as the network controller may not have enough control over the unregulated/unmanaged traffic that contend with the low-latency traffic within the infrastructure basic service set (BSS). Some of the unmanaged traffic that interfere with the AP's BSS' latency sensitive traffic may be coming from uplink (UL)/downlink (DL) or direct link communications within the infrastructure BSS that the AP manages. Other's traffic interference may be due to transmission in the neighboring infrastructure BSS (OBSS). Yet other's traffic interference may be coming from neighboring independent BSS or P2P networks.

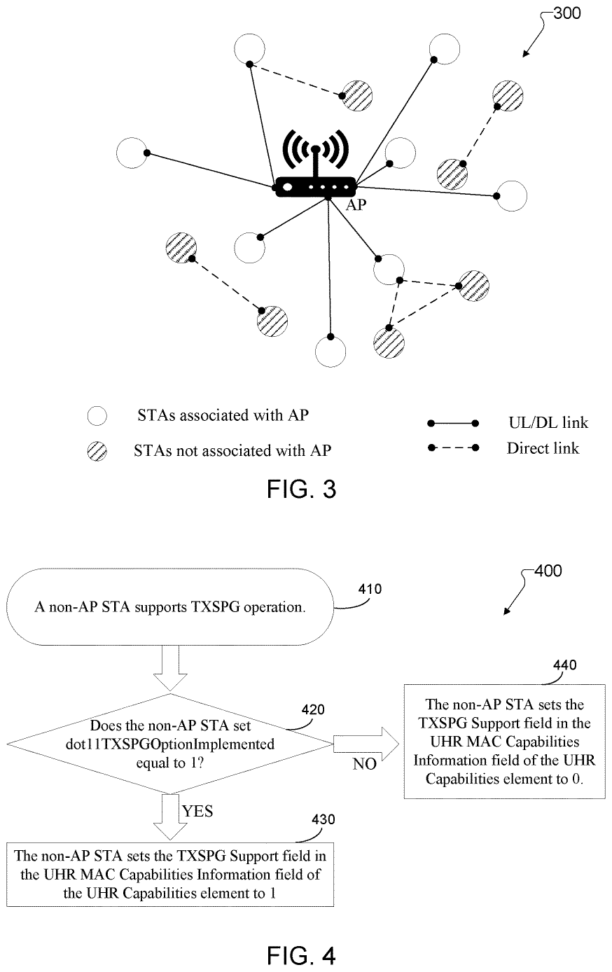

FIG. 3 illustrates an example network 300 where infrastructure traffic and non-infrastructure traffic coexist according to embodiments of the present disclosure. The network 300 is an example of the network 100 in FIG. 1. The network 300 is for illustration only and other embodiments can be used without departing from the scope of the present disclosure.

As illustrated, various STAs are present in the network 300. Certain of the STAs are connected to or associated with the AP. In this manner, the traffic between the associated STAs and the APs may be considered infrastructure traffic. Others of the STAs in the network 300 are not associated with the AP and may communicate directly with one another and/or with an associated STA using P2P communication. P2P communication represents a significant advancement in IEEE 802.11 WLANs, commonly known as Wi-Fi. Wi-Fi networks may rely on an AP to mediate communications between devices. In contrast, P2P communication enables direct data transmission between devices without the need for an intermediate AP. This direct communication is facilitated by standards such as Wi-Fi Direct, which allows devices to establish connections and communicate directly, enhancing efficiency and reducing latency.

The concept of P2P groups extends this capability, enabling multiple devices to form a network where each device can communicate directly with every other member of the group. This setup is particularly useful for applications like file sharing, multiplayer gaming, and streaming media within a local network. The formation of such groups typically involves discovery mechanisms that allow devices to identify potential peers and negotiate group membership. Security is paramount in these groups, ensuring that only authorized devices can join and participate.

There are multiple benefits of P2P groups. By eliminating the need for an AP, they reduce latency and conserve battery life on devices. This makes them good for scenarios requiring real-time communication or energy efficiency. Additionally, P2P groups enable innovative applications such as smart home systems and IoT networks, where direct device interaction is important.

Despite these advantages, embodiments of the present disclosure recognize that challenges exist in managing P2P groups. Coordinating multiple devices without a central AP requires sophisticated mechanisms to allocate resources like bandwidth fairly. Ensuring seamless group management when devices join or leave is also essential to maintain uninterrupted communication.

Standards within the 802.11 family, such as Wi-Fi Direct and potentially other specifications like 802.11z, may provide some framework for these P2P capabilities. These standards ensure compatibility and security, often incorporating encryption methods like WPA2 or WPA3 to protect data integrity.

In terms of addressing and routing, devices in a P2P group utilize unique identifiers such as MAC addresses to target communications accurately. This ensures that data packets reach their intended destinations without confusion.

While P2P groups operate independently of an AP for data transmission, the role of the AP may still be relevant for initial authentication or resource management, ensuring a smooth and secure communication environment.

P2P communication among Wi-Fi client devices may become one of the most consequential “second networks” in wireless systems. While the infrastructure BSS—an AP coordinating multiple STAs—remains the dominant connectivity model, a huge and growing fraction of real user value comes from device-to-device interactions that either bypass the AP's data plane or use the AP only as a facilitator for discovery, security, and policy. Wi-Fi Direct, Wi-Fi Aware (NAN), TDLS (and more generally “D2D over Wi-Fi” patterns), and various vendor-specific derivatives all exist because they solve a practical problem: the endpoints that want to exchange time-sensitive, high-volume, or context-local data are often in the same room, on the same table, or in the same pocket. Various embodiments of the present disclosure recognize and take into consideration that, in those moments, forcing every byte to go through or hairpin through an AP—possibly across congested uplinks, power-saving schedules, and cloud detours—creates avoidable latency, jitter, and energy waste. P2P is a structural pillar of how users experience collaboration, media, gaming, sensing, and control in homes, offices, factories, vehicles, and public spaces. Because P2P traffic still shares spectrum, time, and interference with the infrastructure BSS (and with neighboring BSSs), the quality users perceive depends critically on how well the infrastructure and P2P networks coordinate their operation.

P2P may be framed not as a replacement for the infrastructure network, but as a complementary connectivity layer optimized for proximity, considering the basic economic reality of radio resources: airtime is the currency, and the medium is shared. When two devices are close, a direct link can often use a higher MCS, fewer retransmissions, and shorter on-air time per bit than an AP-mediated path that might require two separate hops (STA→AP and AP→STA) plus additional contention. This translates into higher effective throughput and lower latency for the same spectral footprint-assuming the link is scheduled and controlled intelligently. P2P also avoids needless backhaul dependency for local interactions, improves privacy for local-only exchanges, and enables resilient operation when WAN access is degraded. These experiences are built atop a mix of discovery mechanisms, security associations, and data paths that frequently rely on Wi-Fi P2P primitives because of their performance and power characteristics.

Various embodiments of the present disclosure recognize and take into consideration that Wi-Fi Direct is a visible example which creates a P2P group where one device becomes a P2P Group Owner (GO), effectively acting like a lightweight AP for the group. This model is used for screen casting, printer access, camera-to-phone transfers, on-site provisioning, and temporary collaboration when an infrastructure network is absent or untrusted. From a system standpoint, the GO role has at least two purposes: making the group manageable using familiar AP/STA semantics, and also concentrating scheduling responsibility and power drain on a battery device. That is why coordination with an infrastructure AP—when available—is useful. If the phone is simultaneously a STA in the infrastructure BSS and a GO for a P2P group, the phone becomes a multi-role device with potentially conflicting timing obligations: beacons, DTIM intervals, power save doze/wake patterns, and EDCA contention all interact. Without careful coordination, one role's latency and reliability can collapse under the other role's duty cycle and contention.

Various embodiments of the present disclosure recognize and take into consideration that Wi-Fi Aware (NAN) addresses a different but equally important dimension: discovery and context. Modern systems increasingly depend on for smart home onboarding, proximity-based sharing, multiplayer gaming lobbies, ad-hoc collaboration, retail experiences, and certain IoT workflows. NAN provides an efficient, low-power framework for devices to publish/subscribe services and discover peers without continuous scanning overhead. But discovery is not independent of QoS; discovery is the first step of a workflow that often escalates quickly into data transfer, session control, and real-time interaction. A device might discover a peer while it is already engaged in infrastructure traffic that is delay-sensitive, such as voice, video conferencing, cloud gaming, or uplink sensor telemetry. If discovery and subsequent P2P session establishment are not coordinated with the infrastructure BSS's scheduling and admission control, the system can suffer: a new P2P session begins, consumes contention opportunities, triggers channel switching or off-channel activity, and suddenly the ongoing infrastructure flows experience jitter and packet loss. In well-designed systems, the AP and devices treat P2P initiation not as an isolated event but as a managed resource allocation decision.

Various embodiments of the present disclosure recognize and take into consideration that tunneled direct link setup (TDLS) is often associated with enabling a direct link between two STAs that are already associated to the same AP, with the AP helping set up the security context and link parameters. Conceptually, TLDS is a clean demonstration of the coordination principle: even if the data path becomes direct, the infrastructure association remains important for authentication, policy enforcement, and overall medium coordination. Although TDLS may lack in some adoption scenarios, the underlying idea remains relevant: the “infrastructure network” is not merely a relay; the infrastructure network is the control plane anchor that can arbitrate coexistence between multiple types of traffic and roles. Many platforms may desire to use “TDLS-like” behaviors under different frameworks, especially in enterprise or specialized deployments, because the performance gains can be significant when two devices are close, but the AP is far or congested.

The use of P2P is important beyond file transfer scenarios. Wireless display, multi-room audio synchronization, camera offload, and collaborative editing all benefit from low-latency, high-throughput local links. Gaming is even more demanding: local multiplayer, spectator streaming, and mixed reality experiences often require tight latency bounds and predictable jitter. In AR/VR and spatial computing, motion-to-photon pipelines can tolerate only small bursts of delay before users perceive nausea or discomfort; local P2P links can reduce end-to-end latency by avoiding unnecessary uplink/downlink contention through the AP and by enabling more direct, higher-rate PHY conditions. In a smart home, smart locks, doorbells, cameras, and hubs frequently use local device-to-device coordination for setup, handoff, and fallback control when cloud connectivity is down. In industrial and healthcare environments, local device swarms—tools, scanners, sensors, displays—need robust, policy-driven interactions that cannot rely on an internet round trip. Vehicles are emerging as major Wi-Fi P2P consumers as well, with in-cabin hotspots, device pairing, keyless entry ecosystems, and sensor-assisted experiences that all can utilize proximity communication and low-latency coordination.

All of those scenarios share a constraint: the radio channel is still shared, and contention-based access is inherently stochastic. P2P sessions overlap with infrastructure sessions, and often occur in exactly the moments when users are already pushing the network—video calls, streaming, cloud sync, and background updates. This is why close coordination between the infrastructure network and the P2P network is important. Close coordination between the infrastructure network and the P2P network is the practical requirement for predictable Quality of Service (QoS). In an unmanaged coexistence model, P2P simply becomes “more contenders,” and the system degrades toward the worst-case behavior of carrier-sense multiple access with collision avoidance (CSMA/CA) under high load: increased collisions, backoff inflation, variable queuing delay, and poor tail latency. Modern use case/experiences demand bounded latency and consistent throughput in environments where the offered load and interference can change abruptly. Coordination is how we reconcile those demands with a shared medium.

Various embodiments of the present disclosure recognize and take into consideration that coordination starts with awareness of roles and traffic classes. When a device is simultaneously a STA in an infrastructure BSS and a participant in a P2P session—whether as a Wi-Fi Direct GO, a P2P client, or a NAN participant—the device has to multiplex its radio time across multiple logical networks. If this multiplexing is left to ad hoc scanning and best-effort contention, QoS will be fragile. A coordinated system, by contrast, treats the device as a multi-link, multi-role actor with explicit time budgets and priorities. Even without introducing new primitives, coordination can leverage existing constructs: aligning service periods, synchronizing wake times, managing off-channel operations, and ensuring that high-priority traffic (voice, control, interactive video) is protected from disruption when P2P sessions start or change state. Importantly, coordination is not just about protecting infrastructure traffic from P2P; it is equally about protecting P2P traffic from the infrastructure BSS when the P2P flow is the one that is latency-critical. In a casting session, the P2P stream might be the dominant user experience, and infrastructure background sync should not be allowed to create stutter.

Various embodiments of the present disclosure recognize and take into consideration that a major coordination challenge is that infrastructure APs and P2P groups can have different beaconing and power-save rhythms. Infrastructure networks typically have established beacon intervals, DTIM periods, and potentially scheduled access mechanisms, while Wi-Fi Direct groups have their own beacon cadence and client power-save behavior. If a dual-role device must maintain synchronization with both, it can end up forced into frequent wakeups, increased overhead, and higher contention, which degrades both battery life and QoS. Coordinated operation aims to reduce this cadence mismatch. Practically, that can mean aligning group beacon timing with infrastructure beacons when feasible, using negotiated absence periods where a device can temporarily prioritize one role without disrupting the other, and ensuring that transitions-such as channel switches or role handoffs-occur at predictable points that minimize collisions and missed delivery opportunities. When coordination is done well, the system behaves more like a scheduled network at the moments that matter, while still retaining the flexibility and interoperability of contention-based access.

Various embodiments of the present disclosure recognize and take into consideration that another coordination dimension is channel and bandwidth selection. P2P technologies often select channels based on discovery outcomes, device capabilities, and regulatory constraints, but in dense environments the “best” channel for P2P may be tightly coupled to the infrastructure channel plan. If the infrastructure BSS is operating on a congested channel, starting a P2P session on that same channel may be convenient but harmful to both flows; starting on a different channel might improve throughput but introduces multi-channel concurrency requirements and potential scanning/off-channel overhead. Good coordination is therefore about system-level optimization: including considerations for where should the P2P session live, how should share airtime with existing infrastructure flows, and how to minimize disruptive channel switching. In enterprise deployments, the AP may have visibility into load and interference and can guide devices toward better choices; in consumer environments, platform-level coordination (between STA and P2P managers) becomes crucial. The end goal is consistent: reduce the probability that P2P initiation causes a sudden QoS collapse for either network.

Various embodiments of the present disclosure recognize and take into consideration that QoS assurance also requires coherent prioritization at the MAC layer. Wi-Fi already has EDCA access categories, and modern implementations map application traffic to these categories to some extent. But when introducing simultaneous infrastructure and P2P operation, simple priority tagging is not enough. A device can prioritize its own outgoing packets, but it cannot directly control the behavior of other contenders, including the AP and other STAs, unless there is a shared coordination framework. This is where close cooperation between the infrastructure AP and P2P roles matters: admission control, airtime fairness policies, and scheduling-like behaviors can be applied with a broader view. If the AP understands that a device is engaged in a P2P session with specific latency requirements, the AP can adjust its own transmission patterns—downlink bursting, trigger-based opportunities, or simply moderating best-effort traffic—so that the combined system maintains acceptable tail latency. Likewise, if the P2P group owner understands the infrastructure's constraints, the P2P group owner can shape its beaconing, service periods, and forwarding behavior to avoid starving infrastructure flows.

Various embodiments of the present disclosure recognize and take into consideration that the need for coordination becomes even more pronounced as users move into “multi-device experiences” and “device clouds.” A phone may be simultaneously connected to a home AP, maintaining a low-latency P2P link to a TV for casting, coordinating with earbuds over a different wireless technology, and participating in discovery for nearby devices. But absent coordination, the system can exhibit pathological interactions: off-channel discovery causing missed beacons, power-save transitions causing bursty latency, P2P group maintenance causing periodic contention spikes, and uplink congestion causing downlink stalls. In other words, P2P and infrastructure operation can create each other's worst-case behavior unless the control plane explicitly manages concurrency.

Various embodiments of the present disclosure recognize and take into consideration that, from a broader technology perspective, P2P is also a foundational enabler for edge intelligence and distributed sensing. Devices increasingly collaborate: cameras and phones performing joint capture, phones and laptops co-processing AI workloads, wearables streaming sensor data to a nearby hub for inference, and home devices coordinating automations without cloud round trips. Coordination between infrastructure and P2P networks is what allows these edge workflows to coexist with traditional internet traffic. Coordination between infrastructure and P2P networks is also what allows security and policy to remain coherent. Infrastructure APs often represent the policy boundary for a home or enterprise network: authentication, authorization, and device onboarding policies live there. If P2P sessions form and exchange data outside that boundary without coordination, administrators lose visibility and control, and users can encounter inconsistent security experiences. A coordinated design can keep P2P efficient while still respecting the infrastructure's policy intent.

Various embodiments of the present disclosure recognize and take into consideration that TXOP Sharing for P2P group (TXSPG) is an important features for IEEE 802.11bn (Wi-Fi) and that how to indicate support for this feature is not clear and needs to be clarified. Accordingly, various embodiments of the present disclosure provide for exchange of the capability for TXSPG procedure. Various embodiments of the present disclosure further provide for a device that supports TXSPG, to indicate whether TXOP return procedure is also supported during the TXSPG operation. Various embodiments of the present disclosure further provide a mechanism for indicating capability for TXSPG procedure. Various embodiments of the present disclosure further provide a mechanism to indicate whether TXOP return procedure is supported or not during the TXSPG operation.

FIG. 4 illustrates an example method 400 for capability field setting logic for a STA according to embodiments of the present disclosure. The method 400 of FIG. 4 can be performed by any of the STAs 111-114 of FIG. 1, such as the STA 111 of FIG. 2B, and a corresponding method can be performed by any of the APs 101-103 of FIG. 1, such as AP 101 of FIG. 2A. The method 400 is for illustration only and other embodiments can be used without departing from the scope of the present disclosure.

As illustrated, for a non-AP STA that supports TXSPG operation (410), the STA determines whether the non-AP STA set dot11TXSPGOptionImplemented equal to 1 (420), or in other words whether the non-AP STA supports the TXSPG operation. If so, the non-AP STA sets the TXSPG Support field in the UHR MAC Capabilities Information field of the UHR Capabilities element to 1 (430). If not, the non-AP STA sets the TXSPG Support field in the UHR MAC Capabilities Information field of the UHR Capabilities element to 0 (440).

In one embodiment, a non-AP STA that has dot11TXSPGOptionImplemented equal to 1 supports TXOP sharing with a group of P2P non-AP STAs (TXSPG), is called a TXSPG non-AP STA, and shall set the TXSPG Supported field of the UHR MAC Capabilities Information field of the UHR Capabilities element to 1. A UHR AP that has dot11TXSPGOptionImplemented equal to 1 supports TXOP sharing with a group of P2P non-AP STA, is called a TXSPG AP, and shall set the TXSPG Supported field of the UHR MAC Capabilities Information field of the UHR Capabilities element to 1.

According to one embodiment, a non-AP STA that has dot11TXSPGOptionImplemented equal to 0 may not support TXOP sharing with a group of P2P non-AP STAs (TXSPG), and may set the TXSPG Supported field of the UHR MAC Capabilities Information field of the UHR Capabilities element to 0.

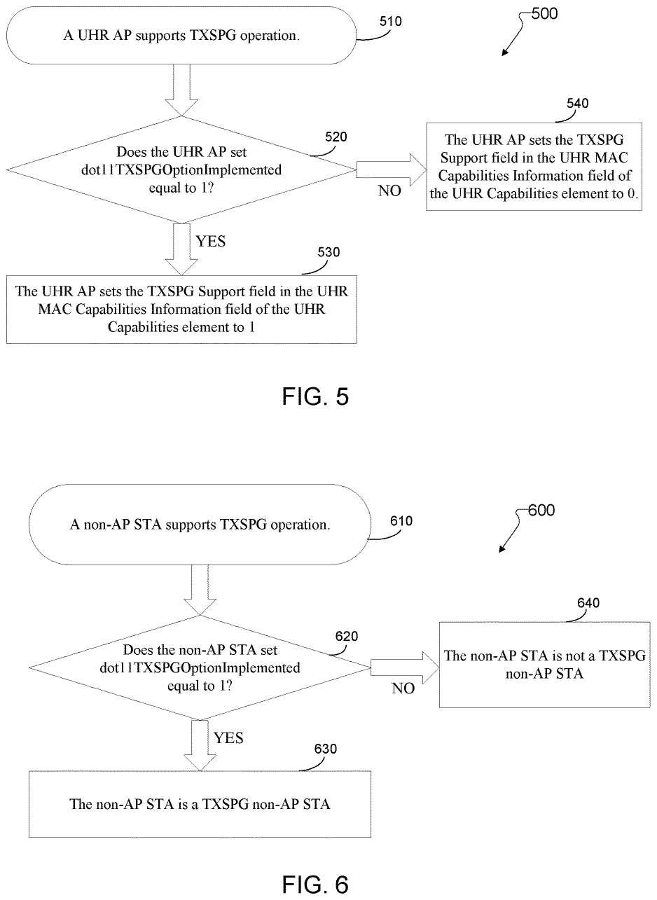

FIG. 5 illustrates an example method 500 for capability field setting logic for a UHR AP according to embodiments of the present disclosure. The method 500 of FIG. 5 can be performed by any of the APs 101-103 of FIG. 1, such as AP 101 of FIG. 2A, and a corresponding method can be performed by any of the STAs 111-114 of FIG. 1, such as the STA 111 of FIG. 2B. The method 500 is for illustration only and other embodiments can be used without departing from the scope of the present disclosure.

As illustrated, for a UHR AP that supports TXSPG operation (510), the UHR AP determines whether the UHR AP set dot11TXSPGOptionImplemented equal to 1 (520), or in other words whether the UHR AP supports the TXSPG operation. If so, the UHR AP sets the TXSPG Support field in the UHR MAC Capabilities Information field of the UHR Capabilities element to 1 (530). If not, the UHR AP sets the TXSPG Support field in the UHR MAC Capabilities Information field of the UHR Capabilities element to 0 (540).

According to one embodiment, a UHR AP that has dot11TXSPGOptionImplemented equal to 0 may not support TXOP sharing with a TXSPG, and may set the TXSPG Supported field of the UHR MAC Capabilities Information field of the UHR Capabilities element to 0.

FIG. 6 illustrates an example method 600 for determining TXSPG non-AP STA status according to embodiments of the present disclosure. The method 600 of FIG. 6 can be performed by any of the STAs 111-114 of FIG. 1, such as the STA 111 of FIG. 2B, and a corresponding method can be performed by any of the APs 101-103 of FIG. 1, such as AP 101 of FIG. 2A. The method 600 is for illustration only and other embodiments can be used without departing from the scope of the present disclosure.

In various embodiments, the rule for determining whether a non-AP STA is a TXSPG non-AP STA is illustrated in FIG. 6. For a non-AP STA that supports TXSPG operation (610), the non-AP STA determines whether it sets dot11TXSPGOptionImplemented equal to 1 (620). If so, the non-AP STA is a TXSPG non-AP STA (630). If not, the non-AP STA is not a TXSPG non-AP STA (640).

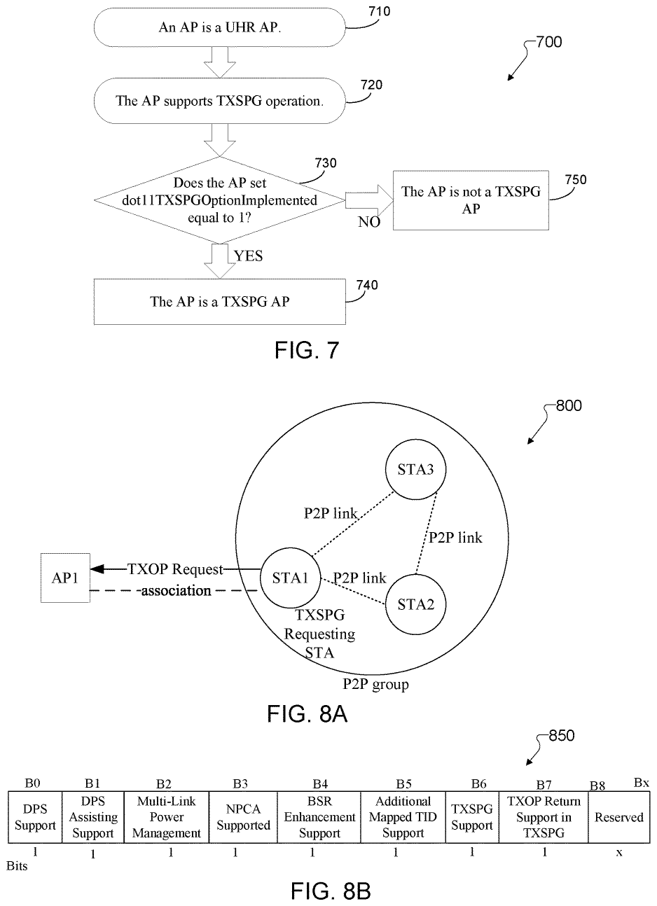

FIG. 7 illustrates an example method 700 for determining TXSPG AP status according to embodiments of the present disclosure. The method 700 of FIG. 7 can be performed by any of the APs 101-103 of FIG. 1, such as AP 101 of FIG. 2A, and a corresponding method can be performed by any of the STAs 111-114 of FIG. 1, such as the STA 111 of FIG. 2B. The method 700 is for illustration only and other embodiments can be used without departing from the scope of the present disclosure.

In various embodiments, the rule for determining whether am AP is a TXSPG AP is illustrated in FIG. 7. For a TXSPG AP that supports TXSPG operation (710), the TXSPG AP determines whether it sets dot11TXSPGOptionImplemented equal to 1 (720). If so, the AP is a TXSPG AP (730). If not, the AP not a TXSPG AP (740).

FIG. 8A a diagram 800 illustrating determination of whether a STA is a TXSPG requesting STA according to embodiments of the present disclosure. The diagram 800 is for illustration only and other embodiments can be used without departing from the scope of the present disclosure.

A TXSPG Requesting STA is a TXSPG non-AP STA that requests the associated AP for TXOP sharing with the P2P group in which the non-AP STA is a member. In various embodiments, the rule for determining whether a non-AP STA is a TXSPG requesting STA a non-AP STA is a TXSPG non-AP STA is illustrated in FIG. 8A. In FIG. 8A, STA1, STA2, and STA3 form a P2P group. STA1 sends a message to its associated AP, where the message contains a request to the AP for allocating TXOP to the P2P group. Accordingly, STA1 is a TXSPG Requesting STA for the P2P group.

FIG. 8B illustrates a format of a UHR MAC capabilities information field 850 according to embodiments of the present disclosure. The UHR MAC capabilities information field 850 s for illustration only and other embodiments can be used without departing from the scope of the present disclosure.

According to one embodiment, an example format of the UHR MAC capabilities information field 850 is shown in FIG. 8B. In these embodiments, certain subfields of the UHR MAC capabilities information field 850 include:

Subfields of the UHR MAC capabilities information field

| Subfield | Definition | Encoding |
|---|---|---|
| . . . | . . . | . . . |
| TXSPG | Indicates whether | Set to 1 to indicate that TXSPG |
| Support | TXSPG operation | operation is supported. |
| | is supported | Set to 0 to indicate that TXSPG |
| | | operation is not supported. |
| TXOP Return | Indicates whether | Set to 1 to indicate that TXOP |
| Support in | TXOP Return | return in TXSPG operation is |
| TXSPG | procedure for | supported. |
| | TXSPG operation | Set to 0 to indicate that TXOP |
| | is supported | return in TXSPG operation is |
| | | not supported. |

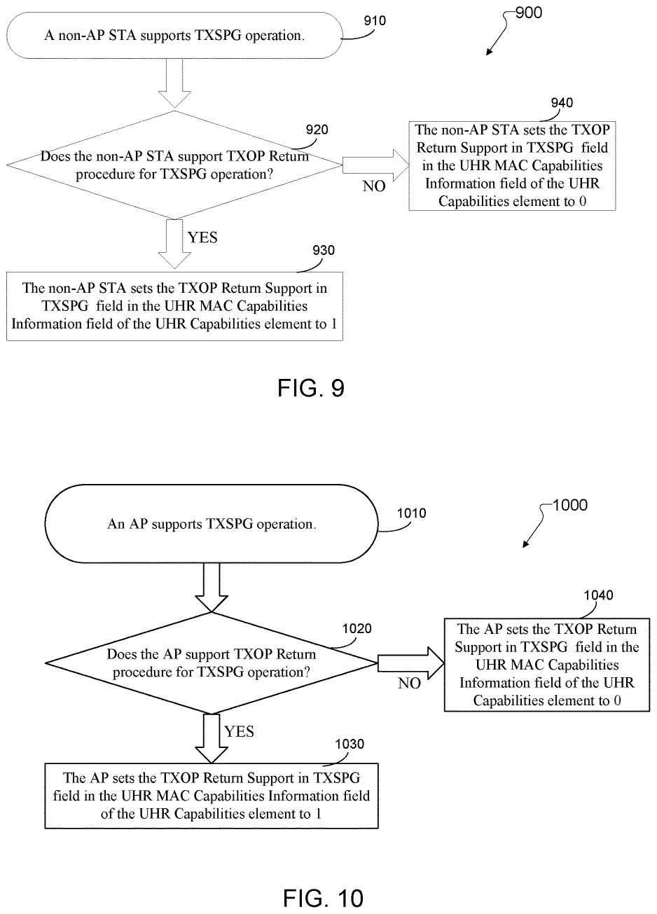

FIG. 9 illustrates an example method 900 for TXOP return support in TXSPG field setting for a non-AP STA according to embodiments of the present disclosure. The method 900 of FIG. 9 can be performed by any of the STAs 111-114 of FIG. 1, such as the STA 111 of FIG. 2B, and a corresponding method can be performed by any of the APs 101-103 of FIG. 1, such as AP 101 of FIG. 2A. The method 900 is for illustration only and other embodiments can be used without departing from the scope of the present disclosure.

In various embodiments, the rule for determining TXOP return support in TXSPG field setting for a non-AP STA is illustrated in FIG. 9. For a non-AP STA that supports TXSPG operation (910), the non-AP STA determines whether it supports a TXOP Return procedure for TXSPG operation (920). If so, the non-AP STA sets the TXOP Return Support in TXSPG field in the UHR MAC Capabilities Information field of the UHR Capabilities element to 1 (930). If not, the non-AP STA sets the TXOP Return Support in TXSPG field in the UHR MAC Capabilities Information field of the UHR Capabilities element to 0 (940).

FIG. 10 illustrates an example method 1000 for TXOP Return support in TXSPG field setting for an AP according to embodiments of the present disclosure. The method 1000 of FIG. 10 can be performed by any of the APs 101-103 of FIG. 1, such as AP 101 of FIG. 2A, and a corresponding method can be performed by any of the STAs 111-114 of FIG. 1, such as the STA 111 of FIG. 2B. The method 1000 is for illustration only and other embodiments can be used without departing from the scope of the present disclosure.

In various embodiments, the rule for rule for TXOP return support in TXSPG field setting for an AP is illustrated in FIG. 10. For an AP that supports TXSPG operation (1010), the AP determines whether it supports TXOP Return procedure for TXSPG operation (1020). If so, the AP sets the TXOP Return Support in TXSPG field in the UHR MAC Capabilities Information field of the UHR Capabilities element to 1 (1030). If not, the sets the TXOP Return Support in TXSPG field in the UHR MAC Capabilities Information field of the UHR Capabilities element to 0 (1040).

According to one embodiment, if an AP or a non-AP STA sets the TXSPG Support field in the UHR MAC Capabilities Information field in the UHR Capabilities element to 0, then the AP or the non-AP STA may (or shall) set the TXOP Return Support in TXSPG field in the UHR MAC Capabilities Information field in the UHR Capabilities element to 0. In other words, if the TXSPG Support field in the UHR MAC Capabilities Information field in the UHR Capabilities element is set to 0, then the TXOP Return Support in TXSPG field in the UHR MAC Capabilities Information field in that UHR Capabilities element may (shall) be set to 0 as well.

According to one embodiment, if an AP or a non-AP STA sets the TXSPG Support field in the UHR MAC Capabilities Information field in the UHR Capabilities element to 0, then the TXOP Return Support in TXSPG field in the UHR MAC Capabilities Information field in the UHR Capabilities element may be Reserved.

According to one embodiment, if an AP or a non-AP STA sets the TXSPG Support field in the UHR MAC Capabilities Information field in the UHR Capabilities element to 1, then the AP or the non-AP STA may set the TXOP Return Support in TXSPG field in the UHR MAC Capabilities Information field in the UHR Capabilities element to either 1 or 0.

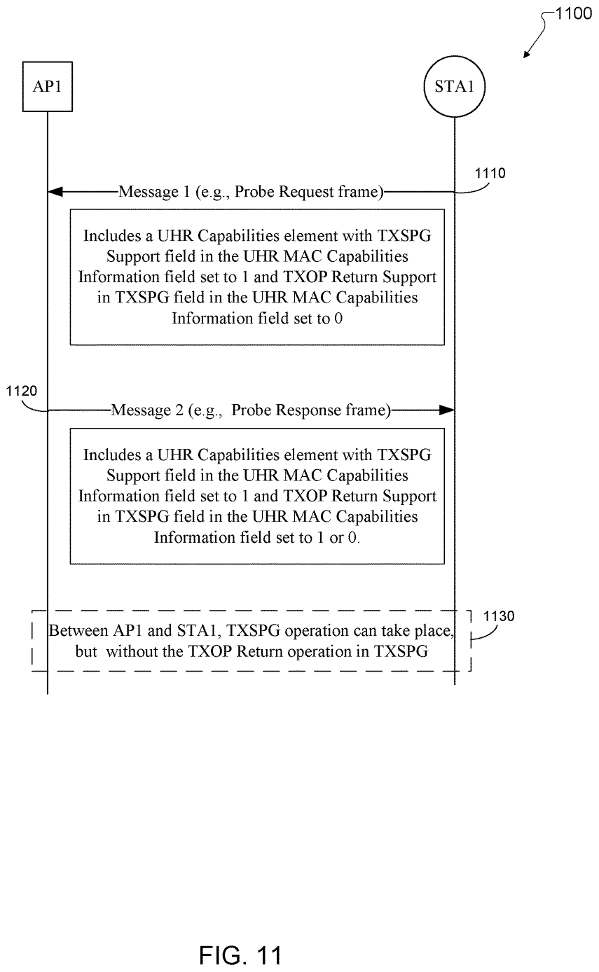

FIGS. 11-15 discussed below illustrates different settings for the TXSPG support field and TXOP return support in TXSPG field, and the corresponding determination of the nature of the TXSPG operation between AP1 (an AP) and STA1 (a non-AP STA) based on the settings of these two fields. In various embodiments, as illustrated in FIGS. 11-15, a probe request frame is used as the frame that contains the UHR capabilities element, where the probe request frame is transmitted by the non-AP STA. A probe response frame is used as the frame that contains the UHR Capabilities element, where the probe response frame is transmitted by the AP. However, other frames could also carry the UHR capabilities element. For example, and without limitation, in other embodiments, if transmitted by the non-AP STA, the UHR capabilities element can also be carried in an associated request frame, reassociation request frame, or other management frame; if transmitted by the AP, the UHR capabilities element can also be carried in an associated response frame, reassociation response frame, beacon frame, or other management frame.

FIG. 11 illustrates an example method 1100 for setting of the TXSPG Support field and TXOP Return Support in TXSPG field, and the corresponding determination of the nature of the TXSPG operation between an AP1 and STA according to embodiments of the present disclosure. The method 1100 of FIG. 11 can be performed between one of the STAs 111-114 of FIG. 1, such as the STA 111 of FIG. 2B and one of the APs 101-103 of FIG. 1, such as AP 101 of FIG. 2A. The method 1100 is for illustration only and other embodiments can be used without departing from the scope of the present disclosure.

As illustrated, the STA1 transmits a message 1 (1110) (e.g., a Probe Request frame). The message 1 includes a UHR Capabilities element with TXSPG support field in the UHR MAC capabilities information field set to 1 and TXOP Return Support in TXSPG field in the UHR MAC capabilities Information field set to 0. The AP1 transmits a message 2 (1120) (e.g., a Probe Response frame). The message 2 includes a UHR Capabilities element with TXSPG Support field in the UHR MAC Capabilities Information field set to 1 and TXOP Return Support in TXSPG field in the UHR MAC Capabilities Information field set to 1 or 0. In this scenario, between AP1 and STA1, TXSPG operation can take place, but without the TXOP Return operation in TXSPG (1130).

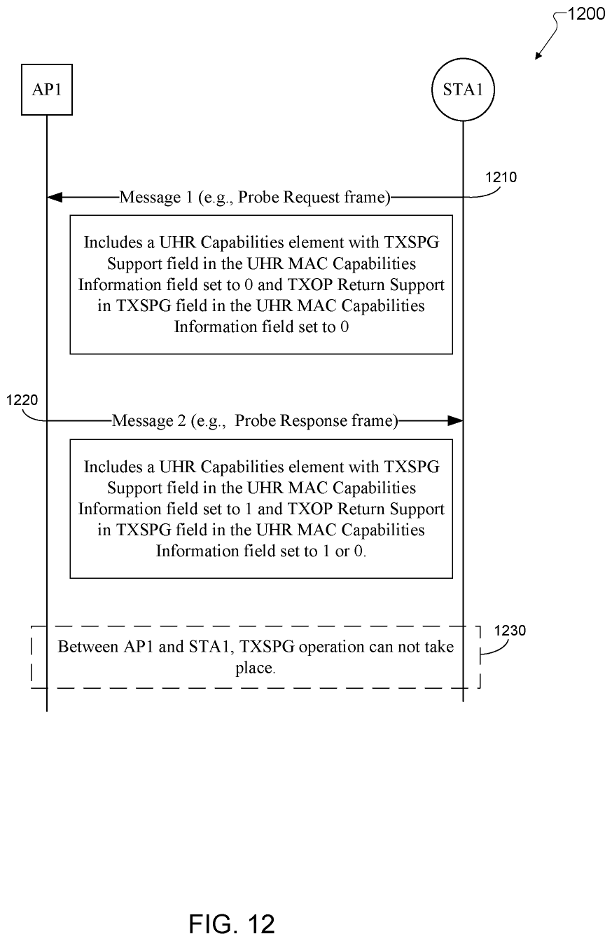

FIG. 12 illustrates an example method 1200 for setting of the TXSPG Support field and TXOP Return Support in TXSPG field, and the corresponding determination of the nature of the TXSPG operation between AP1 and STA1 according to embodiments of the present disclosure. The method 1200 of FIG. 12 can be performed between one of the STAs 111-114 of FIG. 1, such as the STA 111 of FIG. 2B and one of the APs 101-103 of FIG. 1, such as AP 101 of FIG. 2A. The method 1200 is for illustration only and other embodiments can be used without departing from the scope of the present disclosure.

As illustrated, the STA 1 transmits a message 1 (1210) (e.g., a Probe Request frame). The message 1 includes a UHR Capabilities element with TXSPG Support field in the UHR MAC Capabilities Information field set to 0 and TXOP Return Support in TXSPG field in the UHR MAC Capabilities Information field set to 0. The AP1 transmits a message 2 (1220) (e.g., a Probe Response frame). The message 2 includes a UHR Capabilities element with TXSPG Support field in the UHR MAC Capabilities Information field set to 1 and TXOP Return Support in TXSPG field in the UHR MAC Capabilities Information field set to 1 or 0. In this scenario, between AP1 and STA1, TXSPG operation cannot take place (1230).

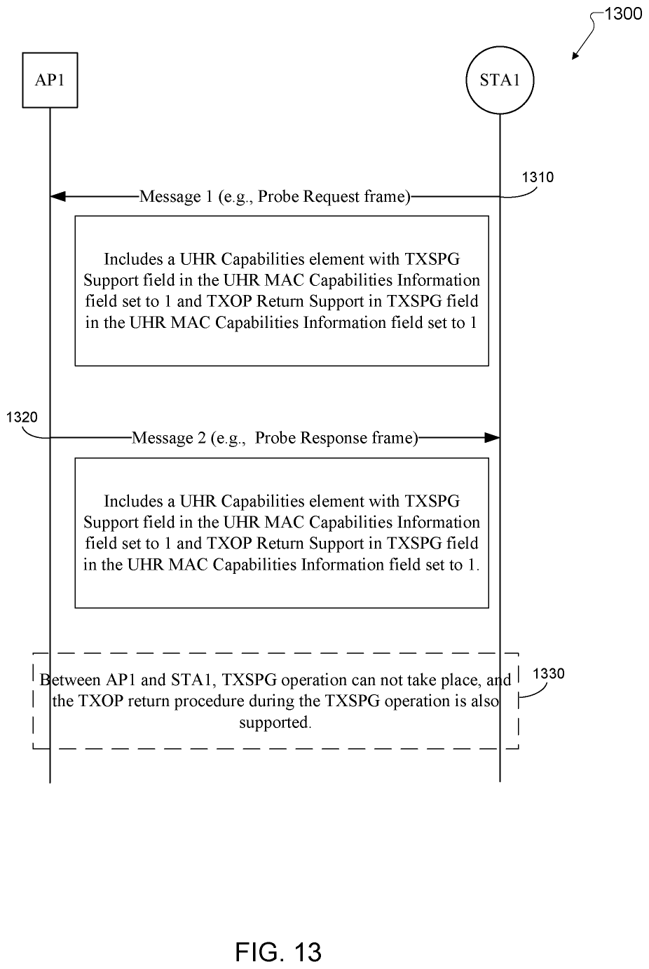

FIG. 13 illustrates an example method 1300 for setting of the TXSPG Support field and TXOP Return Support in TXSPG field, and the corresponding determination of the nature of the TXSPG operation between AP1 and STA1 according to embodiments of the present disclosure. The method 1300 of FIG. 13 can be performed between one of the STAs 111-114 of FIG. 1, such as the STA 111 of FIG. 2B and one of the APs 101-103 of FIG. 1, such as AP 101 of FIG. 2A. The method 1300 is for illustration only and other embodiments can be used without departing from the scope of the present disclosure.

As illustrated, the STA 1 transmits a message 1 (1310) (e.g., a Probe Request frame). The message 1 includes a UHR Capabilities element with TXSPG Support field in the UHR MAC Capabilities Information field set to 1 and TXOP Return Support in TXSPG field in the UHR MAC Capabilities Information field set to 1. The AP1 transmits a message 2 (1320) (e.g., a Probe Response frame). The message 2 includes a UHR Capabilities element with TXSPG Support field in the UHR MAC Capabilities Information field set to 1 and TXOP Return Support in TXSPG field in the UHR MAC Capabilities Information field set to 1. In this scenario, between AP1 and STA1, TXSPG operation cannot take place, and the TXOP return procedure during the TXSPG operation is also supported (1330).

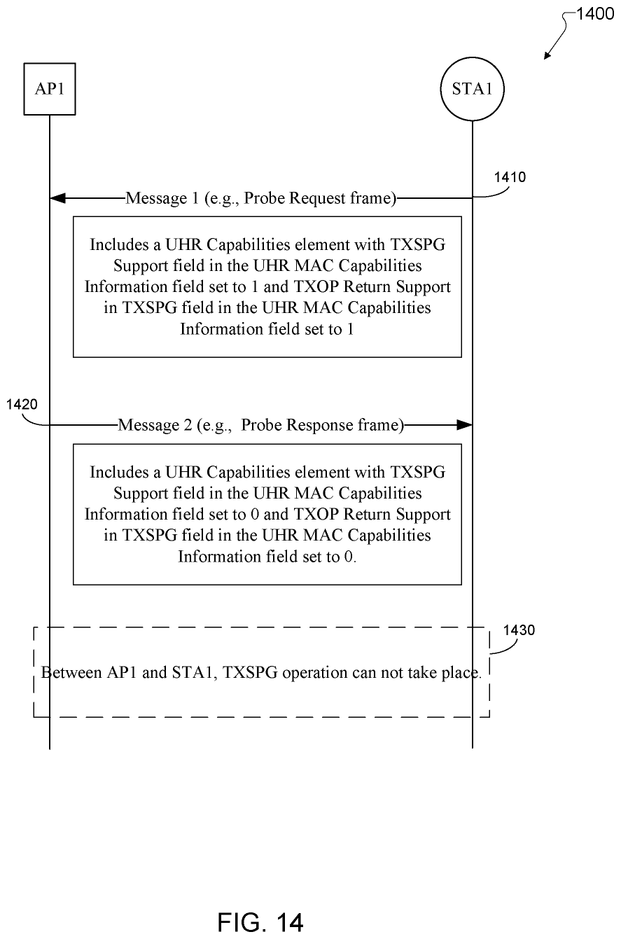

FIG. 14 illustrates an example method 1400 for setting of the TXSPG Support field and TXOP Return Support in TXSPG field, and the corresponding determination of the nature of the TXSPG operation between AP1 and STA1 according to embodiments of the present disclosure. The method 1400 of FIG. 14 can be performed between one of the STAs 111-114 of FIG. 1, such as the STA 111 of FIG. 2B and one of the APs 101-103 of FIG. 1, such as AP 101 of FIG. 2A. The method 1400 is for illustration only and other embodiments can be used without departing from the scope of the present disclosure.

As illustrated, the STA 1 transmits a message 1 (1410) (e.g., a Probe Request frame). The message 1 includes a UHR Capabilities element with TXSPG Support field in the UHR MAC Capabilities Information field set to 1 and TXOP Return Support in TXSPG field in the UHR MAC Capabilities Information field set to 1. The AP1 transmits a message 2 (1420) (e.g., a Probe Response frame) The message 2 includes a UHR Capabilities element with TXSPG Support field in the UHR MAC Capabilities Information field set to 0 and TXOP Return Support in TXSPG field in the UHR MAC Capabilities Information field set to 0. In this scenario, between AP1 and STA1, TXSPG operation cannot take place (1430).

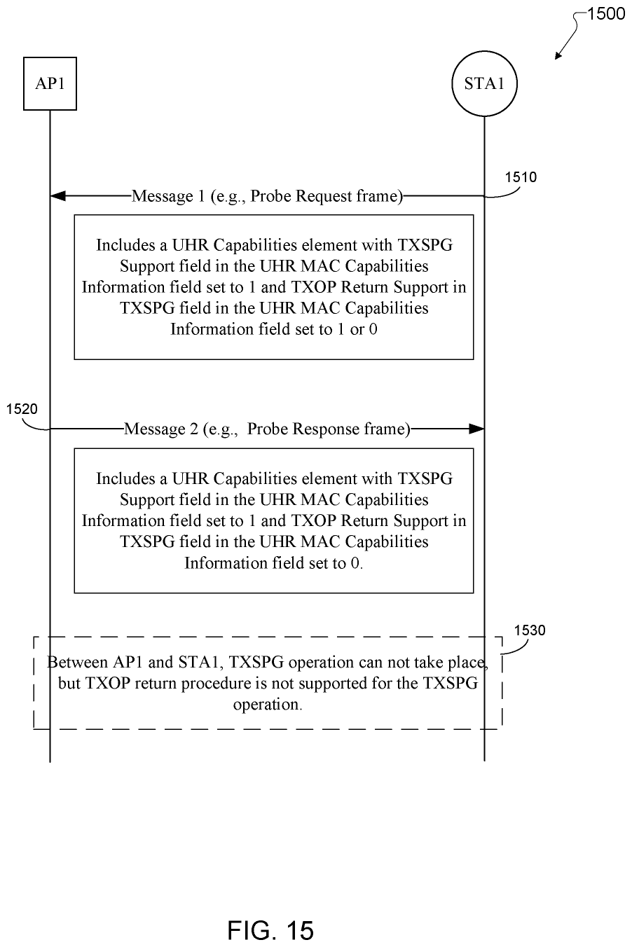

FIG. 15 illustrates an example method 1500 for setting of the TXSPG Support field and TXOP Return Support in TXSPG field, and the corresponding determination of the nature of the TXSPG operation between AP1 and STA1 according to embodiments of the present disclosure. The method 1500 of FIG. 15 can be performed between one of the STAs 111-114 of FIG. 1, such as the STA 111 of FIG. 2B and one of the APs 101-103 of FIG. 1, such as AP 101 of FIG. 2A. The method 1500 is for illustration only and other embodiments can be used without departing from the scope of the present disclosure.

As illustrated, the STA 1 transmits a message 1 (1510) (e.g., a Probe Request frame). The message 1 includes a UHR Capabilities element with TXSPG Support field in the UHR MAC Capabilities Information field set to 1 and TXOP Return Support in TXSPG field in the UHR MAC Capabilities Information field set to 1 or 0. The AP1 transmits a message 2 (1520) (e.g., a Probe Response frame). The message 2 includes a UHR Capabilities element with TXSPG Support field in the UHR MAC Capabilities Information field set to 1 and TXOP Return Support in TXSPG field in the UHR MAC Capabilities Information field set to 0. In this scenario, between AP1 and STA1, TXSPG operation cannot take place, but TXOP return procedure is not supported for the TXSPG operation (1530).

According to one embodiment, the formation of TXSPG groups is facilitated through a discovery mechanism where non-AP STAs broadcast their intent to join a group using specific frames. These frames include parameters such as supported data rates and traffic types, allowing potential members to assess compatibility. The grouping process may involve a centralized AP coordinating memberships or a distributed approach where STAs negotiate directly. This method ensures efficient resource utilization by aligning STAs with similar requirements, thus optimizing TXOP sharing.

According to another embodiment, resource allocation within TXSPG is managed dynamically based on real-time network conditions. The system employs adaptive algorithms that adjust TXOP durations and schedules in response to changing channel quality or traffic loads. For instance, during high interference periods, the TXOP might be shortened to reduce errors, while idle times could extend it for better throughput. This dynamic management enhances overall efficiency and user experience by ensuring resources are used optimally.

According to one embodiment, handling different traffic types within TXSPG involves prioritizing based on QoS requirements. The system classifies traffic into categories like video, voice, or data and allocates TXOPs accordingly. For example, voice traffic might receive shorter, more frequent TXOPs to ensure low latency, while video could use longer bursts for high throughput. This approach ensures that each type of traffic meets its specific service requirements, improving the overall performance.

According to another embodiment, power management techniques are integrated into TXSPG operations to enhance energy efficiency. STAs can enter a low-power state during inactive periods, waking only when their allocated TXOP approaches. The system might also balance resource allocation considering battery levels, prioritizing devices with lower power reserves. This feature is particularly beneficial for IoT devices, extending their operational lifetime without compromising performance.

According to one embodiment, security within TXSPG groups is reinforced through mutual authentication and encryption protocols. Each STA must authenticate with the group using standardized security measures before gaining access to shared resources. Data transmitted during TXOPs is encrypted to prevent eavesdropping, ensuring confidentiality even in shared environments. This layered approach maintains the integrity and security of communications within the group.

According to another embodiment, support for legacy devices alongside TXSPG is achieved through dual-mode operation. The AP can allocate separate TXOPs for legacy STAs while managing advanced sharing groups. This ensures backward compatibility, allowing older devices to coexist with newer ones seamlessly. The system dynamically switches modes based on device capabilities, optimizing performance without excluding any users.

According to one embodiment, dynamic adjustment of TXOP parameters occurs in response to network feedback. The system continuously monitors metrics such as packet loss and latency, adjusting TXOP lengths or schedules to maintain optimal performance. This adaptability ensures that the shared resource allocation remains efficient even as network conditions fluctuate, providing a robust and resilient communication environment.

According to another embodiment, TXSPG is utilized in specific applications like mesh networks or IoT deployments. In such scenarios, the shared TXOPs enable efficient data relaying across multiple nodes, reducing overhead and improving coverage. For IoT, this approach supports large numbers of low-power devices efficiently, making it ideal for smart cities or industrial automation where numerous sensors need reliable communication.

According to one embodiment, coordination between multiple APs handling a single TXSPG group ensures seamless handovers and consistent service. Each AP maintains synchronization with the group's scheduling, allowing STAs to move between coverage areas without disrupting their TXOP allocations. This feature is crucial in dense deployments like stadiums or shopping malls, where maintaining connectivity across APs is essential.

According to another embodiment, integration with advanced Wi-Fi features such as OFDMA enhances TXSPG efficiency. By dividing channels into subcarriers assigned to different STAs, multiple users can share the same TXOP more effectively. This combination maximizes throughput and reduces contention, especially in environments with high device density and diverse traffic demands.

According to one embodiment, a method for establishing a TXSPG group could involve a designated TXSPG GO elected through a P2P negotiation process, potentially leveraging mechanisms defined in specifications like Wi-Fi Direct. This GO, which could be either a non-AP STA or a UHR AP with TXSPG capabilities, would be responsible for managing the group membership and coordinating TXOP sharing among the participating non-AP STAs. The GO would advertise its willingness to manage a TXSPG group within its proximity, and other P2P non-AP STAs supporting TXSPG could send association requests to join the group. The GO would maintain a list of active TXSPG members and could assign unique identifiers to each member within the group to facilitate TXOP allocation and management. This group formation process could be triggered dynamically based on application needs or could be a more semi-permanent configuration.

According to one embodiment, the initiation of TXOP sharing within a TXSPG group could be driven by a non-AP STA within the group that has traffic to transmit and requires a TXOP. This requesting STA would send a TXOP request to the TXSPG GO, indicating the duration and potentially the quality of service requirements for the TXOP. The GO, upon receiving the request, would evaluate the current TXOP availability and the priorities of other members within the group. The GO could then grant a TXOP to the requesting STA, specifying the start time and duration of the allocated TXOP. This allocation information could be communicated to the requesting STA and potentially to other members of the TXSPG group to avoid contention during the granted TXOP.

According to one embodiment, different TXOP sharing schemes could be implemented within a TXSPG group to cater to various use cases. A time-division based scheme could involve the GO assigning fixed or dynamically adjusted time slots to each member of the group for transmission. Alternatively, a traffic-based scheme could involve the GO allocating TXOPs on demand based on the amount and priority of traffic each member needs to send. A priority-based scheme could assign different priority levels to members, and the GO would prioritize TXOP allocation to higher-priority STAs. Combinations of these schemes could also be employed, for instance, by assigning base time slots to all members and then allocating additional TXOPs on demand based on traffic needs and priorities.

According to one embodiment, signaling mechanisms would be crucial for the efficient operation of TXSPG. The TXSPG GO could utilize dedicated management frames or information elements within existing frames (e.g., Beacon frames or Action frames) to advertise the TXOP schedule and availability to the members of the group. When a TXOP is granted to a non-AP STA, the GO could send a control frame to that STA containing the TXOP allocation details, such as start time, duration, and the resource units (RUs) that can be used. Furthermore, non-AP STAs within the TXSPG group could use control frames to notify the GO of their TXOP requests or the completion of their allocated TXOP.

According to one embodiment, mechanisms to handle contention and collisions during shared TXOPs would be necessary. Even with GO-managed TXOP allocation, unforeseen circumstances might lead to overlapping transmissions. To mitigate this, a mechanism similar to CSMA/CA could be employed within the allocated TXOP. Alternatively, the GO could implement a stricter TDMA-like approach where precise timing is enforced, and STAs are expected to transmit only during their allocated slots. If collisions do occur, a retransmission mechanism, possibly coordinated by the GO, could be implemented to ensure reliable delivery of data.

According to one embodiment, security considerations would be paramount for TXOP sharing in a P2P group. The establishment of the TXSPG group and the allocation of TXOPs would need to be protected to prevent unauthorized access and interference. Standard security protocols like Wi-Fi Protected Access (WPA) or more advanced protocols could be used to secure the communication within the TXSPG group, including the exchange of TXOP requests and grants. The GO would be responsible for authenticating and authorizing STAs joining the TXSPG group and for ensuring that only authorized members can participate in TXOP sharing.

According to one embodiment, the interaction of TXSPG with QoS mechanisms would allow for differentiated handling of traffic within the shared TXOPs. When a non-AP STA requests a TXOP, it could indicate the traffic identifiers (TIDs) and associated access categories (ACs) for which the TXOP is needed. The TXSPG GO could then allocate TXOPs taking into account these QoS requirements, ensuring that higher-priority traffic receives preferential access to the medium. This integration with EDCA (Enhanced Distributed Channel Access) or other QoS frameworks would enable support for real-time applications with stringent latency and bandwidth requirements within the TXSPG environment.

According to one embodiment, power saving mechanisms could be integrated with TXSPG to optimize the energy consumption of the participating non-AP STAs. The TXSPG GO could inform the members about the TXOP schedule, allowing STAs that do not have an immediate need to transmit to enter a low-power state until their allocated TXOP or a TXOP relevant to their traffic arrives. The GO itself could also optimize its operation to minimize power consumption when not actively managing TXOP allocations. This integration with power saving features in IEEE 802.11 would be crucial for battery-operated P2P devices participating in TXSPG.

According to one embodiment, a TXSPG Requesting STA, upon having data to transmit within its P2P group, would initiate the TXOP sharing request towards its associated AP by generating a specific management frame or by including a dedicated Information Element (IE) within an existing management frame such as a QoS Control frame. This request would serve as a notification to the AP that the non-AP STA intends to participate in TXOP sharing with other members of its P2P group and requires the AP's coordination or permission to do so. The management frame or IE could contain essential information such as the identifier of the P2P group, the intended duration of TXOP sharing, and potentially the QoS requirements for the traffic intended to be exchanged within the TXOP. The TXSPG Requesting STA would transmit this request frame to the MAC address of its associated AP, adhering to the standard transmission procedures defined in IEEE 802.11.

According to one embodiment, the associated AP, upon receiving a TXOP sharing request from a TXSPG Requesting STA, would evaluate the request based on its current channel conditions, its own traffic load, and its policies regarding TXOP sharing with P2P groups. The AP might also consider whether it is aware of a designated TXSPG GO within the P2P group and potentially communicate with the GO to ascertain the group's ongoing activity and resource needs. If the AP determines that granting the TXOP sharing request is feasible without significantly impacting its primary function of serving associated non-AP STAs, the AP proceeds to allocate a specific time window or resource units (RUs) for the TXSPG activity. The AP could also deny the request if resources are constrained or if allowing TXOP sharing would violate its operational policies.

According to one embodiment, the signaling of the TXOP sharing request from the TXSPG Requesting STA to the associated AP could utilize different mechanisms depending on the level of integration and standardization. A dedicated Action frame subtype could be defined specifically for TXSPG requests, allowing for a clear and unambiguous indication of the STA's intent. Alternatively, an existing control frame, such as a Request to Send (RTS) frame or a QoS Control frame, could be extended with a specific flag or subfield to indicate that the request pertains to TXOP sharing with a P2P group. Furthermore, the request could be embedded within association or reassociation request frames if the need for TXOP sharing is anticipated at the time of association. The choice of signaling mechanism would influence the overhead and complexity of implementing the TXSPG feature.

According to one embodiment, the information included in the TXOP sharing request could encompass several parameters to enable the AP to make informed allocation decisions. The request could specify the MAC addresses of the intended peer STAs within the P2P group with whom the TXOP sharing is desired. It might also include a traffic specification (TSPEC) or similar QoS parameters outlining the bandwidth and latency requirements for the P2P traffic. To facilitate prioritization, the request could indicate the access categories (ACs) associated with the traffic intended for the shared TXOP. Additionally, the requesting STA could suggest a preferred duration for the TXOP or indicate a recurring need for shared TXOPs at specific intervals, allowing the AP to potentially establish a more semi-permanent sharing schedule.

According to one embodiment, the associated AP's response to a TXOP sharing request would inform the TXSPG Requesting STA about the outcome of its request. A positive response could be conveyed through a dedicated Action frame or by including a TXSPG Grant IE in a Clear to Send (CTS) frame or another suitable control frame. This grant would specify the parameters of the allocated TXOP, such as the start time, duration, and the allowed RUs or frequency channels for the P2P communication. A negative response could indicate the reason for denial, such as resource unavailability or policy restrictions, allowing the requesting STA to potentially adjust its request or try again later. The AP's response could be unicast to the requesting STA or, in some scenarios, broadcast to inform other relevant STAs about the TXOP allocation.

According to one embodiment, in the context of multi-link operation (MLO), a TXSPG Requesting STA might need to specify on which of its active links the TXOP sharing with the P2P group is intended to occur. If the P2P group members also support MLO, the request could further indicate the preferred links or band combinations for the shared TXOP. The associated AP, if also an MLD AP, would need to consider the resource availability across its multiple links when processing the TXOP sharing request. The response from the AP could then specify the link(s) and corresponding resource allocation for the TXSPG activity, potentially enabling concurrent TXOP sharing on different links if sufficient resources are available.

According to one embodiment, the TXOP sharing request mechanism could be adapted for different basic service set (BSS) types. In an infrastructure BSS, the request would be directed to the associated AP. In an independent BSS (IBSS) or ad-hoc network, where there is no central AP, a TXSPG-capable STA acting as a group coordinator could manage TXOP sharing among its P2P peers directly through distributed coordination functions or by utilizing specific management frames exchanged within the IBSS. In such a scenario, a STA intending to initiate TXOP sharing would broadcast a request to its peers, and a contention-based or scheduled mechanism, managed by the coordinator, would determine the allocation of transmission opportunities within the P2P group.

According to one embodiment, the TXSPG Requesting STA initiates the request for TXOP sharing by transmitting a specially formatted frame to the associated AP. This frame includes information such as the identity of the P2P group, the number of STAs in the group, and the traffic characteristics requiring shared TXOP allocation. The AP, upon receiving this request, evaluates network conditions, available resources, and group compatibility before granting or denying the request. If granted, the AP schedules and coordinates the TXOP sharing among the group members. This mechanism ensures efficient utilization of wireless resources while maintaining fairness among competing groups.

According to another embodiment, the TXSPG Requesting STA includes additional parameters in its request to specify preferred TXOP durations, intervals, or priority levels for different traffic flows within the P2P group. These parameters are derived from the QoS requirements of applications running on the requesting STA or other members of the group. The AP uses these parameters to fine-tune the TXOP allocations, ensuring that the shared transmissions meet the required performance metrics such as latency, jitter, and throughput. This capability enables the system to support diverse use cases, including real-time video streaming, VoIP, and large file transfers.

According to one embodiment, the TXSPG Requesting STA employs a dynamic request mechanism where it adjusts its TXOP sharing requests based on real-time network feedback. For instance, if the AP indicates high channel utilization or interference levels, the requesting STA may reduce its requested TXOP duration or frequency to avoid contention. Conversely, during periods of low network activity, the requesting STA can increase its TXOP request to maximize throughput for the group. This adaptive behavior is facilitated through continuous monitoring of link quality and traffic patterns.

According to another embodiment, the TXSPG Requesting STA supports multiple simultaneous P2P groups, each with its own TXOP sharing requirements. In such cases, the requesting STA prioritizes its requests based on the urgency or importance of each group's traffic. For example, a video conferencing group may be granted higher priority than a file-sharing group. The AP, in turn, manages these competing priorities by allocating TXOPs in a way that balances throughput and fairness across all groups.

According to one embodiment, the TXSPG Requesting STA leverages advanced MAC layer features such as OFDMA or MU-MIMO to enhance the efficiency of TXOP sharing within the P2P group. By combining shared TXOP allocations with these technologies, multiple STAs within the group can transmit simultaneously on different subcarriers or spatial streams. This significantly improves spectral efficiency and reduces contention, especially in dense environments where multiple devices are competing for channel access.

According to another embodiment, the TXSPG Requesting STA implements a power-saving mechanism during TXOP sharing. For example, non-AP STAs in the P2P group can enter a low-power state during their idle periods within the shared TXOP, waking up only when it is their turn to transmit or receive data. This approach reduces energy consumption while maintaining efficient utilization of wireless resources.

According to one embodiment, the TXSPG Requesting STA includes security credentials in its request to ensure that only authorized STAs can join the P2P group and participate in TXOP sharing. The AP verifies these credentials before granting access, preventing unauthorized devices from exploiting shared resource allocations. This enhances the overall security of the network while maintaining the integrity of the TXOP sharing mechanism.

According to another embodiment, the TXSPG Requesting STA supports legacy devices within the P2P group by enabling a fallback mode for compatibility with older Wi-Fi standards. In this mode, the requesting STA coordinates TXOP allocations in a way that accommodates the limitations of legacy devices while still benefiting from the efficiency gains of TXOP sharing. This ensures seamless coexistence between modern and legacy devices.

According to one embodiment, the TXSPG Requesting STA incorporates feedback mechanisms where group members provide input on the effectiveness of the current TXOP allocations. This feedback is aggregated by the requesting STA and communicated to the AP to optimize future allocations. For example, if a group member consistently experiences packet losses during its allocated TXOP slots, the requesting STA can request adjustments to the schedule or duration.

According to another embodiment, the TXSPG Requesting STA supports scalable TXOP sharing across multiple channels or frequency bands. This allows the P2P group to leverage available spectrum in different bands to maximize throughput and reduce congestion. The requesting STA coordinates these multi-band operations by dynamically switching between channels based on interference levels and bandwidth availability.

According to one embodiment, the TXSPG Requesting STA implements a load-balancing algorithm to distribute TXOP sharing requests across multiple APs when operating in a dense deployment with overlapping coverage from several access points. This ensures that no single AP is overwhelmed with requests, maintaining consistent performance across the network while providing redundancy and failover capabilities.

According to another embodiment, the TXSPG Requesting STA integrates machine learning techniques to predict future traffic patterns within the P2P group and optimize its TXOP sharing requests accordingly. By analyzing historical data and current trends, the requesting STA can proactively adjust its requests to anticipate peaks in demand or changes in network conditions, leading to more efficient resource utilization.

According to one embodiment, the TXSPG Requesting STA supports the use of multiple TXOP sharing groups under a single AP, each with distinct configurations tailored to their specific requirements. This allows for greater flexibility and customization, enabling different P2P groups to coexist on the same network while maintaining optimal performance for each group.

According to another embodiment, the TXSPG Requesting STA enables dynamic membership changes within the P2P group during an ongoing TXOP sharing session. For example, a new STA can join the group by sending a membership request to the requesting STA, which then updates the AP with the revised group configuration. The AP adjusts the TXOP allocations dynamically to accommodate the new member without disrupting the ongoing transmissions.

According to one embodiment, the TXSPG Requesting STA includes quality of service (QoS) metrics in its request to ensure that the shared TXOP allocations align with the performance requirements of each application or traffic type within the P2P group. The AP uses these QoS metrics to prioritize certain traffic flows and allocate resources accordingly, ensuring a consistent and high-quality user experience.

According to another embodiment, the TXSPG Requesting STA supports the integration of external scheduling policies defined by network administrators or applications. These policies can dictate priorities, resource limits, or specific timing constraints for TXOP sharing within the P2P group. The requesting STA enforces these policies when coordinating with the AP and other group members, ensuring compliance with organizational or application-specific requirements.

According to one embodiment, the TXSPG Requesting STA enables real-time monitoring and debugging of TXOP sharing operations through detailed logging and reporting features. These logs include information such as allocated TXOP durations, actual usage patterns, and any errors or conflicts encountered during sharing. This data is invaluable for troubleshooting and optimizing the performance of TXOP sharing in large-scale deployments.

According to another embodiment, the TXSPG Requesting STA supports the use of token-based access control for TXOP sharing within the P2P group. Each member STA is assigned a token that regulates its access to shared resources, ensuring fair usage and preventing any single device from monopolizing the channel. The requesting STA manages the distribution and revocation of tokens based on network policies or performance requirements.

According to one embodiment, the TXSPG Requesting STA implements a fault-tolerant mechanism where it can temporarily assume the role of the AP if the primary AP fails or becomes unavailable. In this scenario, the requesting STA coordinates TXOP sharing directly with other group members until the AP recovers or a new AP takes over. This ensures uninterrupted service and maintains network reliability even in the face of infrastructure failures.

According to another embodiment, the TXSPG Requesting STA supports the use of predictive analytics to forecast network congestion and adjust TXOP sharing requests proactively. By analyzing trends in channel utilization, traffic patterns, and device activity, the requesting STA can anticipate potential bottlenecks and optimize its requests to mitigate their impact on performance.

According to one embodiment, the TXSPG Requesting STA enables seamless handover of ongoing TXOP sharing sessions when a group member moves between different APs or networks. The requesting STA coordinates with the new AP to maintain continuity of service, ensuring that shared transmissions are not interrupted due to mobility-related changes in network connectivity.

According to another embodiment, the TXSPG Requesting STA supports the integration of energy harvesting devices into the P2P group, where these devices have unique power constraints and usage patterns. The requesting STA adapts its TXOP sharing requests to accommodate the limited energy reserves of these devices, ensuring their participation in shared resource allocations while preserving their operational lifespan.

According to one embodiment, the TXSPG Requesting STA implements a distributed scheduling algorithm that allows group members to autonomously negotiate and adjust TXOP allocations without relying solely on the AP. This decentralized approach reduces the load on the AP and enables faster decision-making, especially in scenarios where network conditions change rapidly.

According to another embodiment, the TXSPG Requesting STA supports the use of blockchain technology for secure and transparent management of TXOP sharing agreements within the P2P group. Each transaction, such as a request or allocation adjustment, is recorded in a distributed ledger to ensure accountability and prevent tampering. This provides an additional layer of security and trust in shared resource management.

According to one embodiment, the TXSPG Requesting STA enables dynamic adaptation of TXOP sharing parameters based on user behavior and preferences. For example, if a user prioritizes battery life over throughput, the requesting STA can adjust its TXOP requests to favor shorter, less frequent allocations. This personalized approach enhances user satisfaction by aligning network performance with individual needs.

According to another embodiment, the TXSPG Requesting STA supports the integration of augmented reality (AR) and virtual reality (VR) applications requiring ultra-low latency and high-throughput connections. The requesting STA ensures that these applications receive prioritized TXOP allocations, enabling seamless and immersive experiences even in shared wireless environments.

According to one embodiment, the TXSPG Requesting STA implements a hybrid approach combining centralized and distributed resource management for TXOP sharing. This allows the system to leverage the scalability of decentralized coordination while maintaining the efficiency of centralized oversight, offering the best of both worlds in terms of performance and flexibility.

According to another embodiment, the TXSPG Requesting STA supports the use of AI-driven optimization algorithms that continuously refine TXOP sharing strategies based on network conditions, device behavior, and application requirements. These algorithms learn from historical data and adapt in real-time to achieve optimal resource utilization and user satisfaction

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method performed by a non-access point (AP) station (STA), the method comprising:
identifying whether the non-AP STA supports transmission opportunity (TXOP) sharing for a peer to peer (P2P) group (TXSPG) operation;
setting a value of a TXSPG support field of an ultra-high reliability (UHR) medium access control (MAC) capabilities information field of a UHR capabilities element to indicate whether the non-AP STA supports the TXSPG operation; and
transmitting a frame including the TXSPG supported field.

2. The method of claim 1, further comprising:
transmitting a request, to an AP associated with the non-AP STA, to share a TXOP of the AP with the P2P group of which the non-AP STA is a member,
wherein the value of the TXSPG support field is set to 1 to indicate that the non-AP STA supports the TXSPG operation.

3. The method of claim 2, wherein:
the non-AP STA is a TXSPG non-AP STA by virtue of supporting TXSPG; and
the non-AP STA is a TXSPG requesting STA by virtue of transmitting the request for TXOP sharing.

4. The method of claim 1, further comprising:
identifying whether the non-AP STA supports TXOP return in TXSPG operation; and
setting a value of a TXOP return support in TXSPG field of the UHR MAC capabilities information field of the UHR capabilities element to indicate whether the non-AP STA supports the TXOP return in TXSPG operation.

5. The method of claim 1, further comprising:
receiving, from an AP associated with the non-AP STA, a frame including a UHR capabilities element; and
determining, based on a value of a TXSPG support field of a UHR MAC capabilities information field of the received UHR capabilities element, whether the AP supports the TXSPG operation.

6. The method of claim 1, further comprising:
receiving, from an AP associated with the non-AP STA, a frame including a UHR capabilities element; and
determining, based on a value of a TXOP return support in TXSPG field of a UHR MAC capabilities information field of the received UHR capabilities element, whether the AP supports TXOP return in TXSPG operation.

7. The method of claim 1, further comprising:
performing the TXSPG operation when both the non-AP STA and an AP associated with the non-AP STA support the TXSPG operation; and
performing a TXOP return in TXSPG operation when both the non-AP STA and the AP support the TXOP return in TXSPG operation.

8. A method performed by an access point (AP), the method comprising:
receiving, from a non-AP station (STA), a frame including a transmission opportunity (TXOP) sharing for a peer to peer (P2P) group (TXSPG) support field of an ultra-high reliability (UHR) medium access control (MAC) capabilities information field of a UHR capabilities element;
identifying, based on a value of the TXSPG support field, whether the non-AP STA supports TXSPG operation; and
transmitting a frame to the non-AP station based on the identification.

9. The method of claim 8, further comprising:
receiving a request, from the non-AP STA, to share a TXOP of the AP with the P2P group of which the non-AP STA is a member,
wherein the value of the TXSPG support field is set to 1 to indicate that the non-AP STA supports the TXSPG operation.

10. The method of claim 9, wherein:
the non-AP STA is a TXSPG non-AP STA by virtue of supporting TXSPG; and
the non-AP STA is a TXSPG requesting STA by virtue of transmitting the request for TXOP sharing.

11. The method of claim 8, further comprising:
determining whether the non-AP STA supports TXOP return in TXSPG operation based on a value of a TXOP return support in TXSPG field of the UHR MAC capabilities information field of the UHR capabilities element.

12. The method of claim 8, further comprising:
transmitting, to the non-AP STA, a frame including a UHR capabilities element; and
wherein a value of a TXSPG support field of a UHR MAC capabilities information field of the received UHR capabilities element indicates whether the AP supports the TXSPG operation.

13. The method of claim 8, further comprising:
transmitting, to the non-AP STA, a frame including a UHR capabilities element,
wherein a value of a TXOP return support in TXSPG field of a UHR MAC capabilities information field of the transmitted UHR capabilities element indicates whether the AP supports TXOP return in TXSPG operation.

14. The method of claim 8, further comprising:
performing the TXSPG operation when both the non-AP STA and an AP associated with the non-AP STA support the TXSPG operation; and
performing a TXOP return in TXSPG operation when both the non-AP STA and the AP support the TXOP return in TXSPG operation.

15. A non-access point (AP) station (STA), comprising:
at least one processor including processing circuitry; and
memory storing instructions, wherein the instructions, when executed by the at least one processor individually or collectively, cause the non-AP STA to:
identify whether the non-AP STA supports transmission opportunity (TXOP) sharing for a peer to peer (P2P) group (TXSPG) operation;
set a value of a TXSPG support field of an ultra-high reliability (UHR) medium access control (MAC) capabilities information field of a UHR capabilities element to indicate whether the non-AP STA supports the TXSPG operation; and
transmit a frame including the TXSPG supported field.

16. The non-AP STA of claim 15, wherein the instructions, when executed by the at least one processor individually or collectively, cause the non-AP STA to:
transmit a request, to an AP associated with the non-AP STA, to share a TXOP of the AP with the P2P group of which the non-AP STA is a member,
wherein the value of the TXSPG support field is set to 1 to indicate that the non-AP STA supports the TXSPG operation.

17. The non-AP STA of claim 16, wherein:
the non-AP STA is a TXSPG non-AP STA by virtue of supporting TXSPG; and
the non-AP STA is a TXSPG requesting STA by virtue of transmitting the request for TXOP sharing.

18. The non-AP STA of claim 15, wherein the instructions, when executed by the at least one processor individually or collectively, cause the non-AP STA to:
identify whether the non-AP STA supports TXOP return in TXSPG operation; and
set a value of a TXOP return support in TXSPG field of the UHR MAC capabilities information field of the UHR capabilities element to indicate whether the non-AP STA supports the TXOP return in TXSPG operation.

19. The non-AP STA of claim 15, wherein the instructions, when executed by the at least one processor individually or collectively, cause the non-AP STA to:
receive, from an AP associated with the non-AP STA, a frame including a UHR capabilities element; and
determine, based on a value of a TXSPG support field of a UHR MAC capabilities information field of the received UHR capabilities element, whether the AP supports the TXSPG operation.

20. The non-AP STA of claim 15, wherein the instructions, when executed by the at least one processor individually or collectively, cause the non-AP STA to:
receive, from an AP associated with the non-AP STA, a frame including a UHR capabilities element; and
determine, based on a value of a TXOP return support in TXSPG field of a UHR MAC capabilities information field of the received UHR capabilities element, whether the AP supports TXOP return in TXSPG operation.
